(19) United States
(12) Patent Application Publication
(10) Pub. No.: US 2026/0021557 A1
(43) Pub. Date: Jan. 22, 2026

(54) APPARATUS AND METHOD FOR PROCESSING POLISHING SLURRY

(71) Applicant: MINERAL TECHNOLOGY INTERNATIONAL INC., Hsinchu City (TW)

(72) Inventor: Chih-Chiang YANG, Hsinchu City (TW)

(21) Appl. No.: 18/778,359

(22) Filed: Jul. 19, 2024

(51) Int. Cl. B24B 57/00; B01D 69/04

(52) U.S. Cl. CPC B24B 57/00; B01D 69/04

(57) ABSTRACT

Disclosed is an apparatus and method for processing polishing slurry. The apparatus has a filtration unit, a permeation unit, and a control unit. A transfer pipeline connects the filtration and permeation units. The control unit, which consists primarily of electronic circuits, manages both units. The filtration unit is used to remove multiple first particles larger than a first dimension from the slurry and to transfers the filtered slurry to the permeation unit. The permeation unit is used to remove at least a portion of the second particles that are smaller than a second dimension. This process results in a polishing slurry with a more uniform particle size distribution.

### CROSS-REFERENCE TO RELATED APPLICATIONS

Not applicable

### BACKGROUND OF THE INVENTION

The present invention relates to polishing slurries used in the field of chemical-mechanical polishing. In particular, it relates to an apparatus and a method for processing the polishing slurries.

Chemical-mechanical polishing technology is widely used for the polishing and processing of wafers, and mainly uses polishing pads in combination with polishing slurries to perform polishing, where a polishing platen with the polishing pad faces the wafer and the polishing pad is in contact with the surface of the wafer. As the polishing pad and the wafer move relative to each other, the polishing slurry is supplied between the polishing pad and the wafer to complete the polishing process of the wafer.

The polishing slurry consists primarily of a base liquid with an appropriate proportion of abrasive particles added. The base liquid is a concentrated solution of chemical components mixed with a diluent. During the polishing process, the abrasive particles remove material from the wafer, creating a polishing effect. The particle size of the abrasive particles directly affects the amount of material removed from the wafer. Controlling the particle size of the abrasive particles in the polishing slurry helps to control the surface flatness of the wafer after polishing. However, among the many abrasive particles added to the base liquid, there will inevitably be particles that are too large or too small. If the size distribution of the abrasive particles in the polishing slurry can be made more uniform, it will help improve the quality of the polishing process.

### SUMMARY OF THE INVENTION

The main purpose of the present invention is to provide an apparatus and method for processing polishing slurry.

In order to achieve the above purpose, the present invention adopts the following technical solution:

A polishing slurry processing apparatus, comprising a filtration unit, a permeation unit, a transfer pipeline, and a control unit. Wherein the transfer pipeline connects the filtration unit and the permeation unit. The control unit is mainly composed of electronic circuits and is coupled to the filtration unit and the permeation unit, thereby controlling the filtration unit and the permeation unit.

The filtration unit is used to filter the polishing slurry from an external polishing slurry source, to remove multiple first particles having a particle size greater than a first dimension from the polishing slurry, and to transfer the filtered polishing slurry to the permeation unit through the transfer pipeline.

The permeation unit comprises a permeator having a permeation membrane disposed therein, with a first channel being located on one side of the permeation membrane, and a second channel being located on the other side. One end of the first channel is connected to a first pipeline, which is connected to the transfer pipeline, and the other end of the first channel is connected to a second pipeline, which is used to connect to an external storage tank. One end of the second channel is connected to a third pipeline, which is used to connect to an external base liquid supply source, and the other end of the second channel is connected to a fourth pipeline, which is used to connect to an external container.

Whereby, the polishing slurry flows from the first pipeline through the first channel into the second pipeline, while multiple second particles with a particle size smaller than a second dimension in the polishing slurry permeate through the permeation membrane into the second channel. The base liquid supplied from the base liquid supply source flows from the third pipeline through the second channel into the fourth pipeline and carries the second particles that entered the second channel through the fourth pipeline into the container.

A processing method using the polishing slurry processing apparatus, includes the following steps performed in sequence: introducing polishing slurry: introducing the polishing slurry from the polishing slurry source into the filtration unit; screening and filtering: the filtration unit screens and filters the polishing slurry, removing the multiple first particles with a particle size greater than the first dimension from the polishing slurry; and permeation and removal: the polishing slurry that has passed through the screening and filtering step is introduced into the permeation unit, removing at least a portion or all of the second particles contained in the polishing slurry, resulting in the polishing slurry mainly containing the third particles with particle sizes between the first dimension and the second dimension, thereby obtaining the polishing slurry with a more uniform particle size distribution.

The present invention can remove the first particles having a particle size greater than the first dimension from the polishing slurry and remove most or all of the second particles from the polishing slurry, thereby making the particle size distribution of the abrasive particles in the polishing slurry more uniform. This improves the quality of the polishing process when the polishing slurry is used in the chemical-mechanical polishing process. Moreover, the present invention can be used to process both newly prepared polishing slurries and recycled polishing slurries containing debris from the polishing process.

### BRIEF DESCRIPTION OF DRAWINGS

FIG. 1 is a system architecture diagram of the polishing slurry processing apparatus in a preferred embodiment of the present invention.

FIG. 2 is an axial cross-sectional schematic diagram of the permeator in the preferred embodiment of the present invention.

FIG. 3 is a schematic diagram showing the state of use of the permeator in the preferred embodiment of the present invention.

FIG. 4 is a schematic diagram showing another use state of the permeator in the preferred embodiment of the present invention.

FIG. 5 is a flow chart of the processing method performed by the polishing slurry processing apparatus in the preferred embodiment of the present invention.

FIG. 6 is a particle size distribution curve of the abrasive particles contained in the polishing slurry.

### DETAILED DESCRIPTION OF THE INVENTION

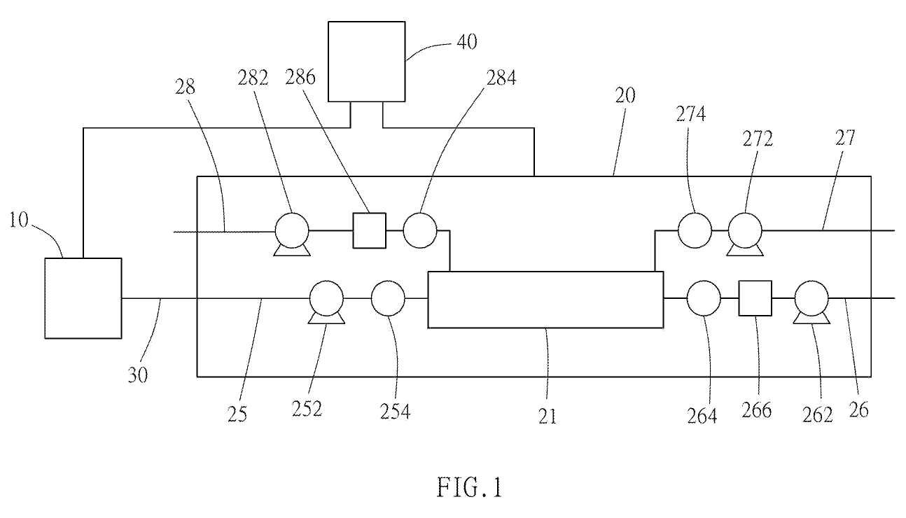

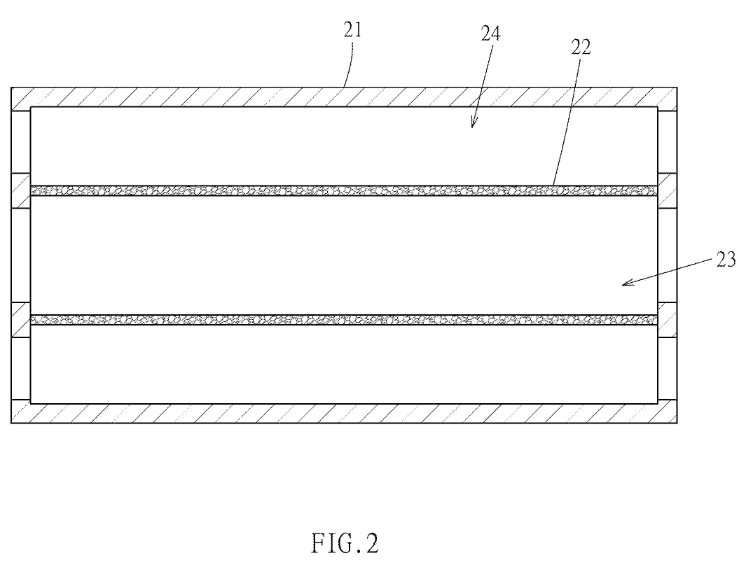

As shown in FIGS. 1 to 3, the polishing slurry processing apparatus of the present invention comprises a filtration unit 10, a permeation unit 20, a transfer pipeline 30, and a control unit 40. The transfer pipeline 30 connects the filtration unit 10 and the permeation unit 20. The control unit 40 is mainly composed of electronic circuits and is coupled to the filtration unit 10 and the permeation unit 20, thereby controlling the filtration unit 10 and the permeation unit 20.

The filtration unit 10 is used to filter the polishing slurry 90 from an external polishing slurry source (not shown), to remove multiple first particles (not shown) having a particle size greater than a first dimension from the polishing slurry 90, and to transfer the filtered polishing slurry 90 to the permeation unit 20 through the transfer pipeline 30. The filtration unit 10 is a prior art that can be directly and unambiguously applied by those skilled in the art of the present invention, and the filtration unit 10 has no necessary connection to the technical features of the present invention, so the specific composition of the filtration unit 10 will not be described in detail.

The permeation unit 20 comprises a permeator 21 having a permeation membrane 22 disposed therein. A first channel 23 is located on one side of the permeation membrane 22, and a second channel 24 is located on the other side. In this embodiment, the permeation membrane 22 has a tubular structure and surrounds the radial outer periphery of the first channel 23 in a ring shape, and the second channel 24 surrounds the radial exterior of the permeation membrane 22.

One end of the first channel 23 is connected to a first pipeline 25, which is connected to the transfer pipeline 30. The other end of the first channel 23 is connected to a second pipeline 26, which is used to connect to an external storage tank (not shown). One end of the second channel 24 is connected to a third pipeline 27, which is used to connect to an external base liquid supply source (not shown). The other end of the second channel 24 is connected to a fourth pipeline 28, which is used to connect to an external container (not shown).

The storage tank is a reservoir used to store the polishing slurry 90 processed by the polishing slurry processing apparatus of the present invention for subsequent application in chemical-mechanical polishing. The base liquid supply source is a container used to store the base liquid 91, which is a liquid composed of a concentrated solution of chemical components mixed with a diluent and does not contain abrasive particles that can remove material from wafers or substrates to produce a polishing effect. The container is a vessel used to hold the slurry-like substance produced after processing by the permeation unit 20, which is a mixture of the base liquid 91 and fine particles, and these particles can be the abrasive particles. The specific compositions of the storage tank, the base liquid supply source, and the container are not particularly limited and are not necessarily related to the technical features of the present invention. Those skilled in the art can directly select various existing reservoirs as the storage tank, the base liquid supply source, and the container.

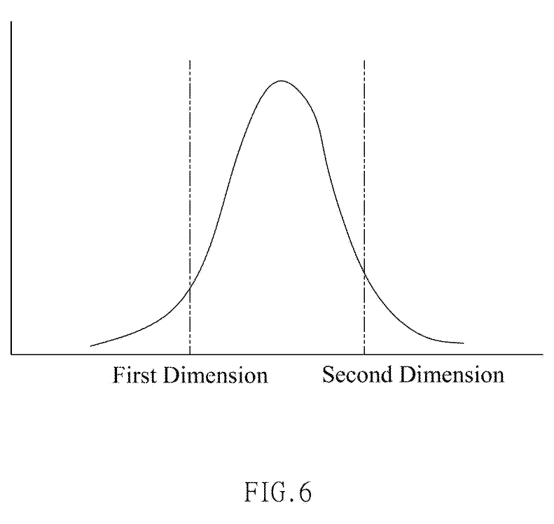

The polishing slurry 90 used in chemical-mechanical polishing consists mainly of the base liquid 91 to which an appropriate proportion of the abrasive particles is added. The particle size distribution curve of these abrasive particles is generally shown in FIG. 6, where the horizontal axis represents the particle size of the abrasive particles and the vertical axis represents the number of the abrasive particles.

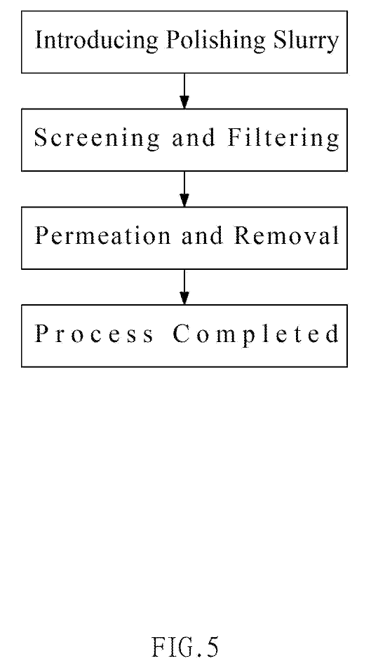

As shown in FIGS. 5 and 6, the processing method performed using the polishing slurry processing apparatus of the present invention includes the following steps performed in sequence:

Introducing Polishing Slurry: Introducing the polishing slurry 90 from the polishing slurry source into the filtration unit 10.

Screening and Filtering: The filtration unit 10 screens and filters the polishing slurry 90, removing the multiple first particles with a particle size greater than the first dimension from the polishing slurry 90.

Permeation and Removal: The polishing slurry 90 that has passed through the screening and filtering step is introduced into the permeation unit 20, removing a portion or all of second particles 92 contained in the polishing slurry 90, resulting in the polishing slurry 90 mainly containing third particles 94 with particle sizes between the first dimension and a second dimension, thereby obtaining the polishing slurry 90 with a more uniform particle size distribution.

The present invention does not limit the specific values of the first dimension and the second dimension. The specific values of the first dimension and the second dimension are preset as needed, and the filtration unit 10 and the permeation membrane 22 with corresponding specifications are selected based on the preset first dimension and the second dimension.

The polishing slurry 90 enters the second pipeline 26 through the first channel 23 from the first pipeline 25. The multiple second particles 92 with a particle size smaller than the second dimension in the polishing slurry 90 permeate through the permeation membrane 22 and enter the second channel 24. The base liquid supply source supplies the base liquid 91 which enters the fourth pipeline 28 through the second channel 24 from the third pipeline 27 and carries the second particles 92 that have entered the second channel 24 into the container through the fourth pipeline 28.

When the polishing slurry processing apparatus of the present invention is used to perform the aforementioned processing method for processing the polishing slurry 90 composed of the base liquid 91 with the appropriate proportion of abrasive particles added thereto, the first particles, the second particles 92, and the third particles 94 are the abrasive particles with different sizes.

Performing the screening and filtering step can use the filtration unit 10 to remove the first particles with a particle size larger than the first dimension from the polishing slurry 90. Performing the permeation and removal step can use the permeation unit 20 to remove most or all of the second particles 92 from the polishing slurry 90, resulting in the polishing slurry 90 consisting primarily of the base liquid 91 and the abrasive particles, with most of the abrasive particles being the third particles 94 having sizes between the first dimension and the second dimension. This makes the particle size distribution of the abrasive particles in the polishing slurry 90 more uniform, thereby improving the quality of the polishing process when the polishing slurry 90 is used in the chemical-mechanical polishing processes.

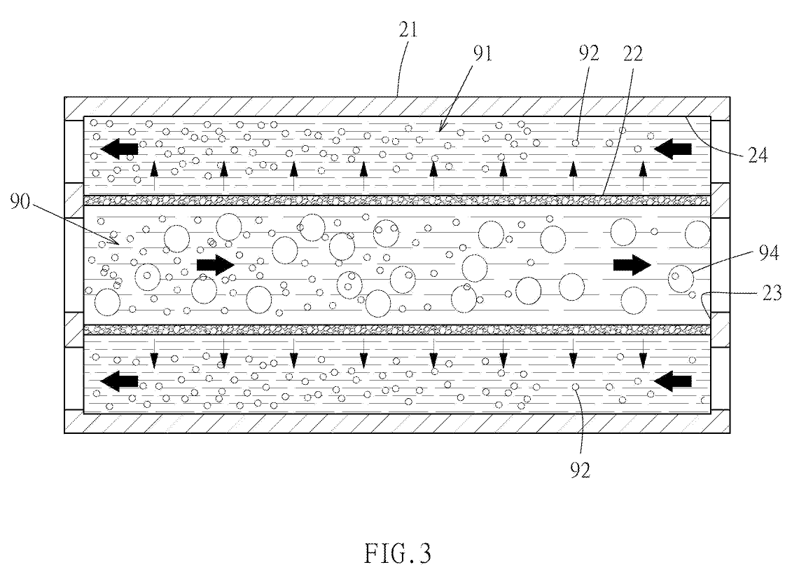

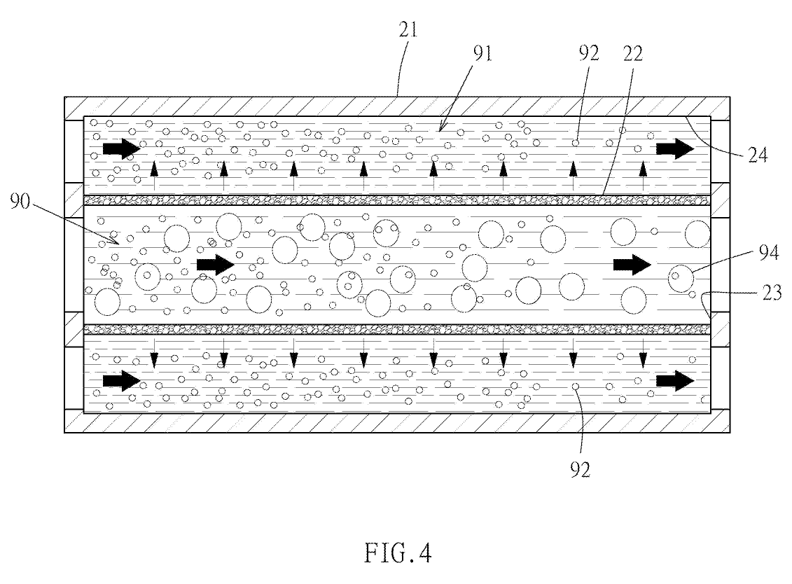

As shown in FIG. 3, the flow direction of the polishing slurry 90 in the first channel 23 is opposite to the flow direction of the base liquid 91 in the second channel 24. As shown in FIG. 4, the flow direction of the polishing slurry 90 in the first channel 23 may also be the same as the flow direction of the base liquid 91 in the second channel 24. FIG. 3 is only an example and should not be construed as a limitation of the present invention.

The base liquid 91 carries the second particles 92 into the container through the second channel 24. The base liquid 91 and the second particles 92 mix to form another type of polishing slurry with a different particle size distribution range, consisting primarily of the base liquid 91 and abrasive particles with sizes smaller than the second dimension. Accordingly, according to the present invention, the second particles 92 with sizes smaller than the second dimension that are removed from the polishing slurry 90 in the permeation and removal step can be recycled and applied in the chemical-mechanical polishing processes as the aforementioned another type of polishing slurry used in finer polishing processes.

The first particles removed from the polishing slurry 90 by the filtration unit 10 during the screening and filtering step can also be recycled and mixed with a new base liquid 91 to be applied in the chemical-mechanical polishing processes as the polishing slurry for coarser polishing processes.

In chemical polishing processes, the fine particulate debris formed by the fragmentation of the wafer and removed by the abrasive particles is carried away from the surface of the wafer or substrate along with the flowing polishing slurry 90, and this debris is fragmented during the polishing process. By performing the above processing method and selecting the value of the second dimension as needed, at least most of this debris can be removed from the polishing slurry 90, allowing the polishing slurry 90 to be recycled in the chemical polishing processes. In this case, the first particles, the second particles 92, and the third particles 94 are used to represent the abrasive particles or debris of different sizes.

Performing the processing method of the present invention can remove the debris from the polishing slurry 90. When the polishing slurry 90 is recycled, the deposition of the debris in the pipelines through which the recycled polishing slurry 90 flows can be reduced, thereby decreasing the probability of the debris accumulation and mutual adhesion to form clumps. This helps to improve the quality and efficiency of the polishing process.

As shown in FIG. 1, the first pipeline 25 is equipped with a first pump 252, used to pump the polishing slurry 90 through the first channel 23 into the second pipeline 26. The third pipeline 27 is equipped with a third pump 272, used to pump the base liquid 91 through the second channel 24 into the fourth pipeline 28. The control unit 40 is coupled to the first pump 252 and the third pump 272 and controls their operation to ensure that the pressure in the second pipeline 26 is greater than or equal to the pressure in the third pipeline 27.

During the permeation and removal step, the pressure of the polishing slurry 90 passing through the first channel 23 on one side of the permeation membrane 22 is greater than the pressure in the second channel 24 on the other side of the permeation membrane 22. This causes the second particles 92 to permeate through the permeation membrane 22 into the second channel 24, and the second particles 92 that have entered the second channel 24 cannot reverse-permeate through the permeation membrane 22 back into the first channel 23.

The second pipeline 26 is equipped with a second pump 262, used to draw the polishing slurry 90 through the first channel 23 and pump the polishing slurry 90 containing the multiple third particles 94 with sizes between the first dimension and the second dimension into the storage tank. The fourth pipeline 28 is equipped with a fourth pump 282, used to draw the base liquid 91 containing the multiple second particles 92 through the second channel 24 and pump the base liquid 91 containing the multiple second particles 92 into the container, wherein the control unit 40 is coupled to control the second pump 262 and the fourth pump 282.

The first pipeline 25 is equipped with a first flow-pressure sensor 254 located between the first pump 252 and the permeator 21, used to sense the pressure of the polishing slurry 90 passing through the first pipeline 25. The second pipeline 26 is equipped with a second flow-pressure sensor 264 located between the second pump 262 and the permeator 21, used to sense the pressure of the polishing slurry 90 passing through the second pipeline 26. The third pipeline 27 is equipped with a third flow-pressure sensor 274 located between the third pump 272 and the permeator 21, used to sense the pressure of the base liquid 91 passing through the third pipeline 27. The fourth pipeline 28 is equipped with a fourth flow-pressure sensor 284 located between the fourth pump 282 and the permeator 21, used to sense the pressure of the base liquid 91 passing through the fourth pipeline 28. The first flow-pressure sensor 254, the second flow-pressure sensor 264, the third flow-pressure sensor 274, and the fourth flow-pressure sensor 284 are each coupled to the control unit 40. Accordingly, the control unit 40 can control the operation of the first pump 252, the second pump 262, the third pump 272, and the fourth pump 282, respectively, based on the detections from the first flow-pressure sensor 254, the second flow-pressure sensor 264, the third flow-pressure sensor 274, and the fourth flow-pressure sensor 284, thereby ensuring that the pressure of the polishing slurry 90 passing through the first channel 23 on one side of the permeation membrane 22 is greater than the pressure in the second channel 24 on the other side of the permeation membrane 22.

The second pipeline 26 is equipped with a second flow meter 266 located between the second pump 262 and the second flow-pressure sensor 264, used to sense the flow rate of the polishing slurry 90 passing through the second pipeline 26. The fourth pipeline 28 is equipped with a fourth flow meter 286 located between the fourth pump 282 and the fourth flow-pressure sensor 284, used to sense the flow rate of the base liquid 91 passing through the fourth pipeline 28. The second flow meter 266 and the fourth flow meter 286 are each coupled to the control unit 40, allowing the control unit 40 to adjust the flow rates of the polishing slurry 90 and the base liquid 91 passing through the permeator 21 by controlling the second pump 262 and the fourth pump 282 based on the flow rates detected by the second flow meter 266 and the fourth flow meter 286.

1. A polishing slurry processing apparatus, comprising a filtration unit, a permeation unit, a transfer pipeline, and a control unit, wherein the transfer pipeline connects the filtration unit and the permeation unit, and the control unit is mainly composed of electronic circuits and is coupled to the filtration unit and the permeation unit, thereby controlling the filtration unit and the permeation unit;
the filtration unit is used to filter the polishing slurry from an external polishing slurry source, to remove multiple first particles having a particle size greater than a first dimension from the polishing slurry, and to transfer the filtered polishing slurry to the permeation unit through the transfer pipeline;
the permeation unit comprises a permeator having a permeation membrane disposed therein, with a first channel being located on one side of the permeation membrane, and a second channel being located on the other side; one end of the first channel is connected to a first pipeline, which is connected to the transfer pipeline, and the other end of the first channel is connected to a second pipeline, which is used to connect to an external storage tank; and one end of the second channel is connected to a third pipeline, which is used to connect to an external base liquid supply source, and the other end of the second channel is connected to a fourth pipeline, which is used to connect to an external container;
whereby, the polishing slurry flows from the first pipeline through the first channel into the second pipeline while multiple second particles with a particle size smaller than a second dimension in the polishing slurry permeate through the permeation membrane into the second channel, and the base liquid supplied from the base liquid supply source flows from the third pipeline through the second channel into the fourth pipeline and carries the second particles that entered the second channel through the fourth pipeline into the container.

2. The polishing slurry processing apparatus according to claim 1, wherein the first pipeline is equipped with a first pump, used to pump the polishing slurry through the first channel into the second pipeline, and the third pipeline is equipped with a third pump, used to pump the base liquid through the second channel into the fourth pipeline, wherein the control unit is coupled to the first pump and the third pump, and the pressure in the second pipeline is greater than or equal to the pressure in the third pipeline.

3. The polishing slurry processing apparatus according to claim 1, wherein the second pipeline is equipped with a second pump, used to draw the polishing slurry through the first channel and pump the polishing slurry containing multiple third particles with sizes between the first dimension and the second dimension into the storage tank, and the fourth pipeline is equipped with a fourth pump, used to draw the base liquid containing the multiple second particles through the second channel and pump the base liquid containing the multiple second particles into the container, wherein the control unit is coupled to the second pump and the fourth pump.

4. The polishing slurry processing apparatus according to claim 2, wherein the second pipeline is equipped with a second pump, used to draw the polishing slurry through the first channel and pump the polishing slurry containing multiple third particles with sizes between the first dimension and the second dimension into the storage tank, and the fourth pipeline is equipped with a fourth pump, used to draw the base liquid containing the multiple second particles through the second channel and pump the base liquid containing the multiple second particles into the container, wherein the control unit is coupled to the second pump and the fourth pump.

5. The polishing slurry processing apparatus according to claim 3, wherein the first pipeline is equipped with a first flow-pressure sensor located between the first pump and the permeator, used to sense the pressure of the polishing slurry passing through the first pipeline, the second pipeline is equipped with a second flow-pressure sensor located between the second pump and the permeator, used to sense the pressure of the polishing slurry passing through the second pipeline, the third pipeline is equipped with a third flow-pressure sensor located between the third pump and the permeator, used to sense the pressure of the base liquid passing through the third pipeline, and the fourth pipeline is equipped with a fourth flow-pressure sensor located between the fourth pump and the permeator, used to sense the pressure of the base liquid passing through the fourth pipeline, wherein the first flow-pressure sensor, the second flow-pressure sensor, the third flow-pressure sensor, and the fourth flow-pressure sensor are each coupled to the control unit.

6. The polishing slurry processing apparatus according to claim 4, wherein the first pipeline is equipped with a first flow-pressure sensor located between the first pump and the permeator, used to sense the pressure of the polishing slurry passing through the first pipeline, the second pipeline is equipped with a second flow-pressure sensor located between the second pump and the permeator, used to sense the pressure of the polishing slurry passing through the second pipeline, the third pipeline is equipped with a third flow-pressure sensor located between the third pump and the permeator, used to sense the pressure of the base liquid passing through the third pipeline, and the fourth pipeline is equipped with a fourth flow-pressure sensor located between the fourth pump and the permeator, used to sense the pressure of the base liquid passing through the fourth pipeline, wherein the first flow-pressure sensor, the second flow-pressure sensor, the third flow-pressure sensor, and the fourth flow-pressure sensor are each coupled to the control unit.

7. The polishing slurry processing apparatus according to claim 5, wherein the second pipeline is equipped with a second flow meter located between the second pump and the second flow-pressure sensor, used to sense the flow rate of the polishing slurry passing through the second pipeline, and the fourth pipeline is equipped with a fourth flow meter located between the fourth pump and the fourth flow-pressure sensor, used to sense the flow rate of the base liquid passing through the fourth pipeline, wherein the second flow meter and the fourth flow meter are each coupled to the control unit.

8. The polishing slurry processing apparatus according to claim 6, wherein the second pipeline is equipped with a second flow meter located between the second pump and the second flow-pressure sensor, used to sense the flow rate of the polishing slurry passing through the second pipeline, and the fourth pipeline is equipped with a fourth flow meter located between the fourth pump and the fourth flow-pressure sensor, used to sense the flow rate of the base liquid passing through the fourth pipeline, wherein the second flow meter and the fourth flow meter are each coupled to the control unit.

9. The polishing slurry processing apparatus according to claim 1, wherein the permeation membrane has a tubular structure and surrounds the first channel, and the second channel surrounds the radial exterior of the permeation membrane.

10. A processing method using the polishing slurry processing apparatus according to claim 1, including the following steps performed in sequence:
introducing polishing slurry: introducing the polishing slurry from the polishing slurry source into the filtration unit;
screening and filtering: the filtration unit screens and filters the polishing slurry, removing the multiple first particles with a particle size greater than the first dimension from the polishing slurry; and
permeation and removal: the polishing slurry that has passed through the screening and filtering step is introduced into the permeation unit, removing at least a portion or all of the second particles contained in the polishing slurry, resulting in the polishing slurry mainly containing the third particles with particle sizes between the first dimension and the second dimension, thereby obtaining the polishing slurry with a more uniform particle size distribution.

11. The processing method according to claim 10, wherein during the permeation and removal step, the pressure of the polishing slurry passing through the first channel on one side of the permeation membrane is greater than the pressure in the second channel on the other side of the permeation membrane, causing the second particles to permeate through the permeation membrane into the second channel.

12. The processing method according to claim 10, wherein during the permeation and removal step, the base liquid is introduced into the permeator to carry away the second particles within the second channel.

13. The processing method according to claim 11, wherein during the permeation and removal step, the base liquid is introduced into the permeator to carry away the second particles within the second channel.
